(19) United States
(12) Patent Application Publication
(10) Pub. No.: US 2016/0111904 A1
(43) Pub. Date: Apr. 21, 2016

(54) Multi-function Apparatus

(71) Applicant: Aurosens Inc., Taipei (TW)

(72) Inventors: GARY SHAW, Sunnyvale, CA (US); ERIC LEE, San Jose, CA (US)

(21) Appl. No.: 14/516,542

(22) Filed: Oct. 16, 2014

(51) Int. Cl. H02J 7/00

(52) U.S. Cl. CPC H02J 7/0052

(57) ABSTRACT

A multi-function apparatus includes an energy storage element; a full bridge circuit, including a first node; a second node; a first switch; a second switch; a third switch; and a fourth switch; and a center segment, electrically connected between the first node and the second node, including a source unit, for providing a charging current to the energy storage element when the source unit is connected to an external energy source; and a load unit, for loading a discharging current provided from the energy storage element when the source unit is not connected to the external energy source.

### BACKGROUND OF THE INVENTION

1. Field of the Invention

The present invention relates to a multi-function apparatus, and more particularly, to a multi-function apparatus in which different functional units share a common structure of circuit.

2. Description of the Prior Art

Portable electronic devices, such as cell phones, Bluetooth headsets, hearing aids, etc., become popular in the current mobile era. These electronic devices comprise a plurality of functional modules, e.g., an amplifier, an analog to digital converter, a digital to analog converter, an audio speaker, a battery charging. Meanwhile, sizes of the electronic devices are required to be smaller. Space is therefore a precious resource when designing an electronic device.

In comparison to digital modules in the electronic device, analog modules need larger space, especially analog modules which large electric currents flow through, e.g., an audio speaker, a battery charging, etc. Nevertheless, circuitry of similar topology maybe comprised indifferent analog modules. In the prior art, since each functional module occupies a separate area within the electronic device, space occupation by these similar circuits is duplicated, causing a waste of space utilization. In such a situation, how to design a multi-function apparatus with a smaller layout area is a significant objective in the field.

### SUMMARY OF THE INVENTION

It is therefore a primary objective of the present invention to provide a multi-function apparatus in which different functional units share a common structure of circuit.

The present invention discloses a multi-function apparatus, comprising an energy storage element, comprising a positive electrode and a negative electrode; a full bridge circuit, connected to the energy storage element in parallel, comprising a first node; a second node; a first switch, electrically connected between the positive electrode of the energy storage element and the first node; a second switch, electrically connected between the positive electrode of the energy storage element and the second node; a third switch, electrically connected between the first node and the negative electrode of the energy storage element; and a fourth switch, electrically connected between the second node and the negative electrode of the energy storage element; and a center segment, electrically connected between the first node and the second node, comprising a source unit, electrically connected between the first node and the second node, for providing a charging current to the energy storage element when the source unit is connected to an external energy source; and a load unit, electrically connected between the first node and the second node, for loading a discharging current provided from the energy storage element when the source unit is not connected to the external energy source.

The present invention further discloses another multi-function apparatus, comprising a first node; a first energy storage element, comprising a positive electrode and a negative electrode connected to the first node; a second energy storage element, comprising a positive electrode connected to the first node and a negative electrode; a half bridge circuit, having a terminal connected to the positive electrode of the first energy storage element and another terminal connected to the negative electrode of the second energy storage element, comprising a second node; a first switch, electrically connected between the positive electrode of the first energy storage element and the second node; a second switch, electrically connected between the second node and the negative electrode of the second energy storage element; and a center segment, electrically connected between the first node and the second node, comprising a source unit, electrically connected between the first node and the second node, for providing a charging current to the energy storage element when the source unit is connected to an external energy source; and a load unit, electrically connected between the first node and the second node, for loading a discharging current provided from the energy storage element when the source unit is not connected to the external energy source.

The present invention further discloses another multi-function apparatus, comprising an energy storage element, comprising a positive electrode and a negative electrode; a full bridge circuit, connected to the energy storage element in parallel, comprising a first node; a second node; a first switch, electrically connected between the positive electrode of the energy storage element and the first node; a second switch, electrically connected between the positive electrode of the energy storage element and the second node; a third switch, electrically connected between the first node and the negative electrode of the energy storage element; and a fourth switch, electrically connected between the second node and the negative electrode of the energy storage element; and a combined segment, electrically connected between the first node and the second node, comprising a rotor, configured to provide a charging current to the energy storage element when an external energy is driving the rotor, and configured to load a discharging current provided from the energy storage element when no external energy is driving the rotor.

The present invention further discloses another multi-function apparatus, comprising a first node; a first energy storage element, comprising a positive electrode and a negative electrode connected to the first node; a second energy storage element, comprising a positive electrode connected to the first node and a negative electrode; a half bridge circuit, having a terminal connected to the positive electrode of the first energy storage element and another terminal connected to the negative electrode of the second energy storage element, comprising a second node; a first switch, electrically connected between the positive electrode of the first energy storage element and the second node; a second switch, electrically connected between the second node and the negative electrode of the second energy storage element; and a combined segment, electrically connected between the first node and the second node, comprising a rotor, configured to provide a charging current to the energy storage element when an external energy is driving the rotor, and configured to load a discharging current provided from the energy storage element when no external energy is driving the rotor.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a multi-function apparatus.

FIG. 2 is a schematic diagram of an implementation of a multi-function apparatus in FIG. 1 using an integrated circuit.

FIG. 3 is a schematic diagram of a multi-function apparatus according to an embodiment of the present invention.

FIG. 4 is a schematic diagram of an implementation of a multi-function apparatus in FIG. 3 using an integrated circuit according to an embodiment of the present invention.

FIG. 5 is a schematic diagram of a multi-function apparatus according to an embodiment of the present invention.

FIG. 6 is a schematic diagram of a multi-function apparatus according to an embodiment of the present invention.

FIG. 7 is a schematic diagram of a multi-function apparatus according to an embodiment of the present invention.

FIG. 8 is a schematic diagram of a multi-function apparatus applying to an UPS system according to an embodiment of the present invention.

FIG. 9 is a schematic diagram of a multi-function apparatus according to an embodiment of the present invention.

FIG. 10 is a schematic diagram of a multi-function apparatus according to an embodiment of the present invention.

FIG. 11 is a schematic diagram of a multi-function apparatus according to an embodiment of the present invention.

### DETAILED DESCRIPTION

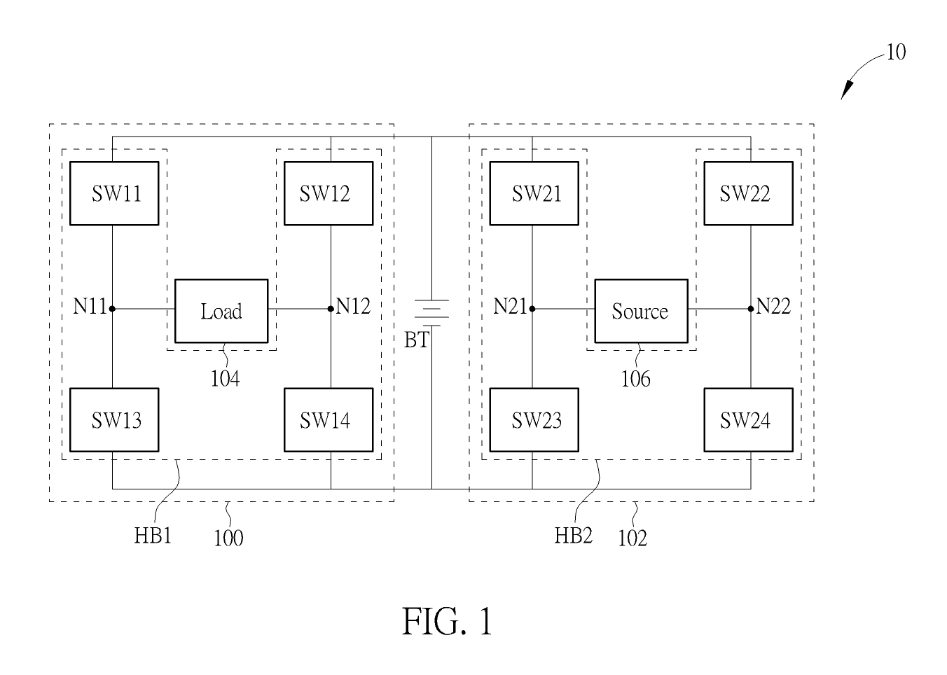

Please refer to FIG. 1, which is a schematic diagram of a multi-function apparatus 10. The multi-function apparatus 10 comprises an energy storage element BT, a loading module 100 and a charger module 102. The energy storage element BT may be a rechargeable battery, a capacitor, etc., and not limited therein. The energy storage element BT comprises a positive electrode and a negative electrode. The loading module 100 comprises a load unit 104 and a full bridge circuit HB1. The full bridge circuit HB1 comprises nodes N11, N12 and switches SW11-SW14. The charger module 102 comprises a source unit 106 and a full bridge circuit HB2. The full bridge circuit HB2 comprises nodes N21, N22 and switches SW21-SW24.

Furthermore, the source unit 106 may be connected to an external energy source (not illustrated), which provides a higher electric potential than the energy storage element BT. The external energy source maybe an AC power source, a secondary of a power transformer, etc. When the source unit 106 is connected to the external energy source, the charger module 102 provides a current to the energy storage element BT and charges the energy storage element BT. Otherwise, when the source unit 106 is not connected to the external energy source, the energy storage element BT discharges and provides a current to the loading module 100.

Specifically, in the full bridge circuit HB1, the switch SW11 is electrically connected between the positive electrode of the energy storage element BT and the node N11, the switch SW12 is electrically connected between the positive electrode of the energy storage element and the node N12, the switch SW13 is electrically connected between the node N11 and the negative electrode of the energy storage element BT; the switch SW14 is electrically connected between the node N12 and the negative electrode of the energy storage element BT. Moreover, the switches SW11, SW14 and the switches SW12, SW13 are controlled to be turned on alternatively, i.e., the switches SW11, SW14 are turned on when the switches SW12, SW13 are turn off and the switches SW12, SW13 are turned on when the switches SW11, SW14 are turned off. A structure and operational principles of the full bridge circuit HB2 are similar to the full bridge circuit HB1, which are not narrated herein for brevity. Since the full bridge circuit HB1 and the full bridge circuit HB2 are common structures for the loading module 100 and the charger module 102, layout areas of the full bridge circuits of the multi-function apparatus 10 are occupied twice, causing an overuse of space.

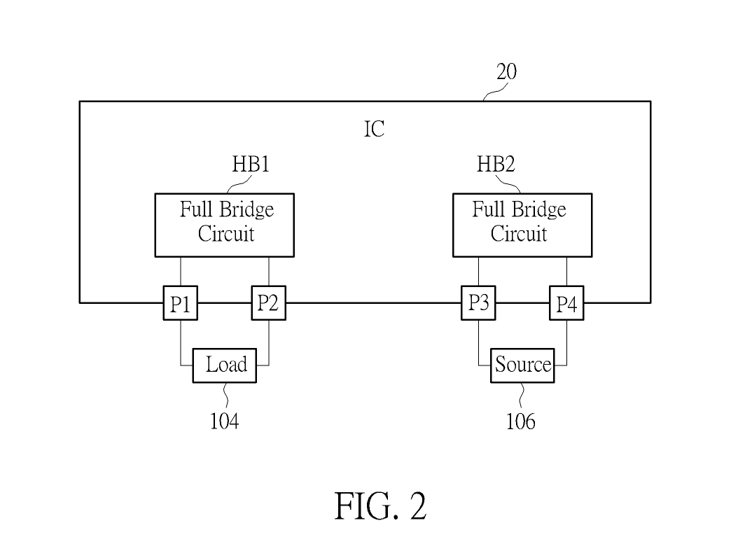

In addition, please refer to FIG. 2, which is a schematic diagram of an implementation of the multi-function apparatus 10 using an integrated circuit (IC) 20. As shown in FIG. 2, the integrated circuit 20 comprises the full bridge circuit HB1, the full bridge circuit HB2, and pins P1-P4. The load unit 104 and the source unit 106 are connected to the full bridge circuit HB1 and the full bridge circuit HB2 via the pins P1-P4, which means that the integrated circuit 20 spends four pins to connect to the load unit 104 and the source unit 106, causing an overuse of pins allocation.

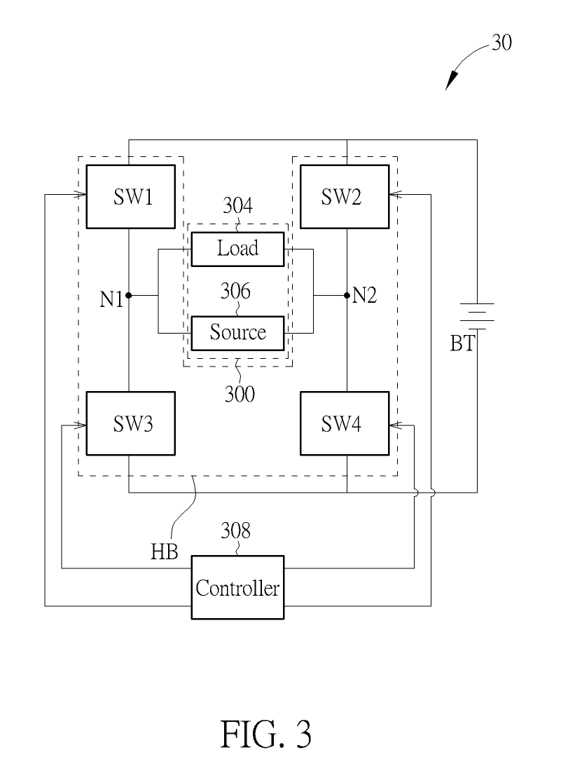

Therefore, the present invention further provides a multi-function apparatus capable of reducing the usage of layout area and number of pins. Please refer to FIG. 3, which is a schematic diagram of a multi-function apparatus 30 according to an embodiment of the present invention. As shown in FIG. 3, the multi-function apparatus 30 comprises a full bridge circuit HB, an energy storage element BT, a center segment 300 and a controller 308. The full bridge circuit HB comprises nodes N1-N2 and switches SW1-SW4. The switches SW1-SW4 are bi-directional switches, capable of conducting electric currents from a first terminal to a second terminal of each switch as well as from the second terminal to the first terminal after turned on. The switches SW1-SW4 may be metal oxide semiconductor (MOS) transistors. Similar to the full bridge circuit HB1 in FIG. 1, the switches SW1 and SW4 are controlled by the controller 308 to be on for conducting the charging current to the energy storage element from the source unit or conducting the discharging current to the load unit from the energy storage element, the switches SW2 and SW3 are controlled by the controller 308 to be turned on or turned off simultaneously, and the switches SW1 and SW2 are controlled by the controller 308 not to be on for conducting the charging current to the energy storage element from the source unit or conducting the discharging current to the load unit from the energy storage element.

Furthermore, the center segment 300 comprises a load unit 304 and a source unit 306. The center segment 300, the load unit 304 and the source unit 306 are electrically connected between the node N1 and the node N2. The load unit 304 is a load device such as a speaker. The source unit 306 may be connected to an external energy source (not illustrated), e.g., an AC power source, a secondary of a power transformer, which provides a higher electric potential than the energy storage element BT.

Under a situation that the source unit 306 is connected to the external energy source, when an end of the source unit 306 connected to the node N1 has a higher voltage than the positive electrode of the energy storage element BT, the switches SW1 and SW4 are controlled to be turned on and the switches SW2 and SW3 are turned off. Hence, the source unit 306 provides a current flowing through the switches SW1 and SW4 to charge the energy storage element BT. Similarly, when the end of the source unit 306 connected to the node N2 has a higher voltage than the positive electrode of the energy storage element BT, the switches SW2 and SW3 are controlled to be turned on and the switches SW1 and SW4 are turned off. Hence, the source unit 306 may provide a current flowing through the switches SW2 and SW3 to charge the energy storage element BT. In such a situation, the full bridge circuit HB functions as a battery charger synchronous rectifier.

On the other hand, under another situation that the source unit 306 is not connected to the external energy source, when the switches SW1 and SW4 are controlled to be turned on and the switches SW2 and SW3 are turned off, the energy storage element BT discharges and provides a current flowing through the switches SW1, SW4 and the load unit 304. Similarly, when the switches SW2 and SW3 are controlled to be turned on and the switches SW1 and SW4 are turned off, the energy storage element BT discharges and provides a current flowing through the switches SW2, SW3 and the load unit 304. Notably, when the switches SW1 and SW4 are on, the current flows from the node N1 through the load unit 304 to the node N2; when the switches SW2 and SW3 are on, the current flows from the node N2 through the load unit 304 to the node N1, which means that the current directions flowing through the load unit 304 are opposite, depending on the switch on-off conditions. For the load unit 304 being a speaker, the opposite current directions, along with different speed and amount of current, generate different acoustic waves, and thus the speaker generates different sounds. In such a situation, the full bridge circuit HB functions as an audio speaker driver.

In another perspective, under a condition that the switches SW1 and SW4 are on, when the full bridge circuit HB functions as the battery charger synchronous rectifier, the current flows from the node N2 through the source unit 306 to the node N1. When the full bridge circuit HB functions as the audio speaker driver, the current flows from the node N1 through the load unit 304 to the node N2. On the other hand, under another condition that the switches SW2 and SW3 are on, when the full bridge circuit HB functions as the battery charger synchronous rectifier, the current flows from the node N1 through the source unit 306 to the node N2. When the full bridge circuit HB functions as the audio speaker driver, the current flows from the node N2 through the load unit 304 to the node N1.

Notably, in the multi-function apparatus 30, the full bridge circuit HB shared by the load unit 304 and the source unit 306 plays two roles of the audio speaker driver and the battery charger synchronous rectifier alternatively. Therefore, the multi-function apparatus 30 utilizes smaller layout area than the multi-function apparatus 10, and achieves the same goal implementing both functions.

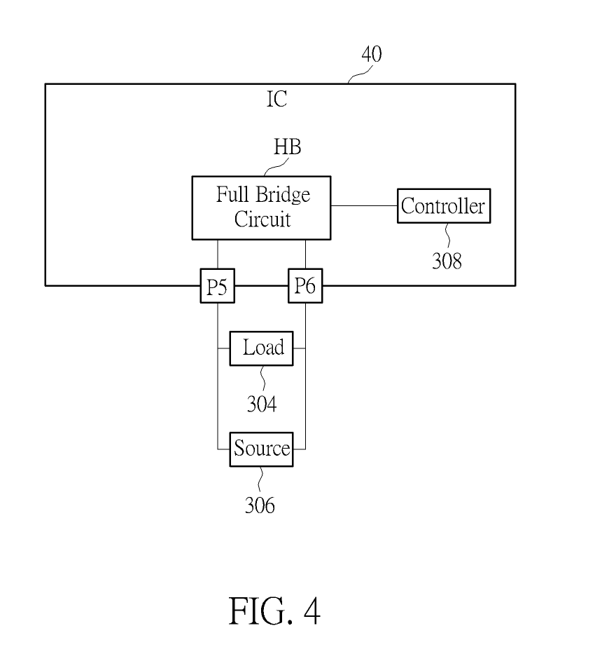

In addition, please refer to FIG. 4, which is a schematic diagram of the multi-function apparatus 30 implemented by an integrated circuit 40 according to an embodiment of the present invention. As shown in FIG. 4, the load unit 304 and the source unit 306 are connected to the full bridge circuit HB via the pins P5-P6. In comparison, the integrated circuit 40 spends only two pins, less than the pin number which the integrated circuit 20 uses. As can be seen from the above, the multi-function apparatus 30 of the present invention sharing the full bridge circuit HB reduces the usage of layout areas and pins.

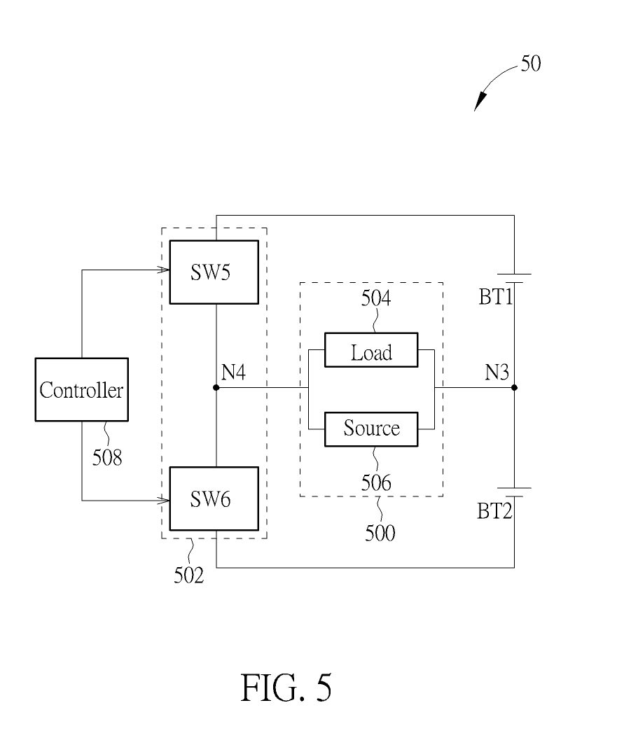

A concept of sharing a bridge circuit maybe extended. Please refer to FIG. 5, which is a schematic diagram of a multi-function apparatus 50 according to an embodiment of the present invention. The multi-function apparatus 50 comprises a node N3, energy storage elements BT1-BT2, a center segment 500, a half bridge circuit 502, and a controller 508. Each of the energy storage elements BT1-BT2 comprises a positive electrode and a negative electrode. The node N3 is connected to the negative electrode of the energy storage element BT1 and the positive electrode of the energy storage element BT2. The half bridge circuit 502 comprises a node N4 and switches SW5, SW6. The switches SW5, SW6 are also bi-directional switches as the switches SW1-SW4, which may be MOS transistors. The switch SW5 is electrically connected between the positive electrode of the energy storage element BT1 and the node N4. The switch SW6 is electrically connected between the node N4 and the negative electrode of the energy storage element BT2. The switches SW5 and SW6 are controlled by the controller 508 to be turned on alternatively. The center segment 500 comprises a load unit 504 and a source unit 506. A structure of the center segment 500 is similar to the center segment 300, which is not narrated herein for brevity.

Similar to the operational principles of the multi-function apparatus 30, under a situation that the source unit 506 is connected to the external energy source, when an end of the source unit 506 connected to the node N4 has a higher voltage than the positive electrode of the energy storage element BT1, the switch SW5 is controlled to be turned on and the switch SW6 is turned off. The source unit 506 provides a current flowing through the switch SW5 to charge the energy storage element BT1. Similarly, when the end of the source unit 506 connected to the node N3 has a higher voltage than the positive electrode of the energy storage element BT2, the switch SW6 is controlled to be turned on and the switch SW5 is turned off. The source unit 506 provides a current flowing through the switch SW6 to charge the energy storage element BT2. In such a situation, the half bridge circuit functions as a battery charger synchronous rectifier.

On the other hand, under a situation that the source unit 506 is not connected to the external energy source, when the switch SW5 is controlled to be turned on and the switch SW6 is turned off, the energy storage element BT1 discharges and provides a current flowing through the switch SW5 to the load unit 504. Similarly, when the switch SW6 is controlled to be turned on and the switch SW5 is turned off, the energy storage element BT2 discharges and provides a current flowing to the load unit 504 through the switch SW6. Notably, when the switch SW5 is on, the current flows from the node N4 through the load unit 504 to the node N3; when the switch SW6 is on, the current flows from the node N3 through the load unit 504 to the node N4, which means that current directions flowing through the load unit 504 are opposite, depending on the switch on-off conditions. For the load unit 504 being a speaker load, the opposite current directions, along with different speed and amount of current, generate different acoustic waves, and thus the speaker generates different sounds. In such a situation, the half bridge circuit functions as an audio speaker driver. Features of the multi-function apparatus 50 reducing the usage of areas and pins by sharing the half bridge circuit is similar to the multi-function apparatus 30, which are not narrated herein for brevity.

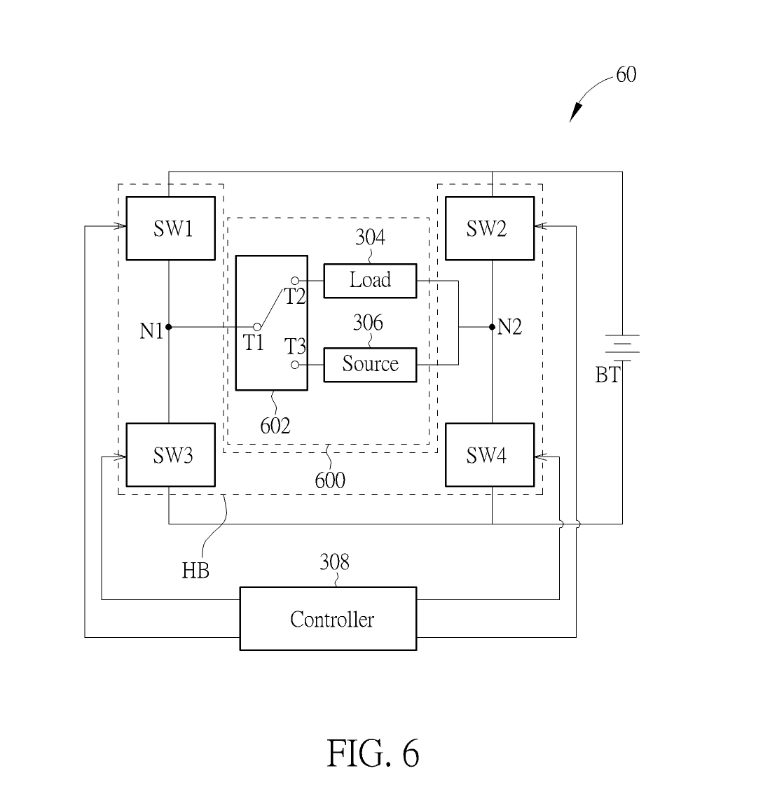

Notably, the multi-function apparatus 30 and the multi-function apparatus 50 are exemplary embodiments of the present invention. Those skilled in the art may make modifications and alternations accordingly. For example, please refer to FIG. 6, which is a schematic diagram of a multi-function apparatus 60 according to an embodiment of the present invention. The multi-function apparatus 60 is similar to the multi-function apparatus 30, and thus, the same units are denoted by the same symbols. Different from the multi-function apparatus 30, a center segment 600 of the multi-function apparatus 60 further comprises a switching unit 602. As shown in FIG. 6, the switching unit 602 comprises a terminal T1 electrically connected to the node N1, a terminal T2 electrically connected to the load unit 304, and a terminal T3 electrically connected to the source unit 306. The switching unit 602 is controlled to conduct either a connection between the terminal T1 and the terminal T2 of the switching unit 602, or a connection between the terminal T1 and the terminal T3 of the switching unit 602. The switching unit 602 is controlled to determine which part of function of the multi-function apparatus 60 is activated. Specifically, when the connection between the terminal T1 and the terminal T3 is conducted, the full bridge circuit HB in the multi-function apparatus functions as a battery charger synchronous rectifier. On the other hand, given that the load unit 306 is a speaker load, when the connection between the terminal T1 and the terminal T2 is conducted, the full bridge circuit HB in the multi-function apparatus functions as an audio speaker driver.

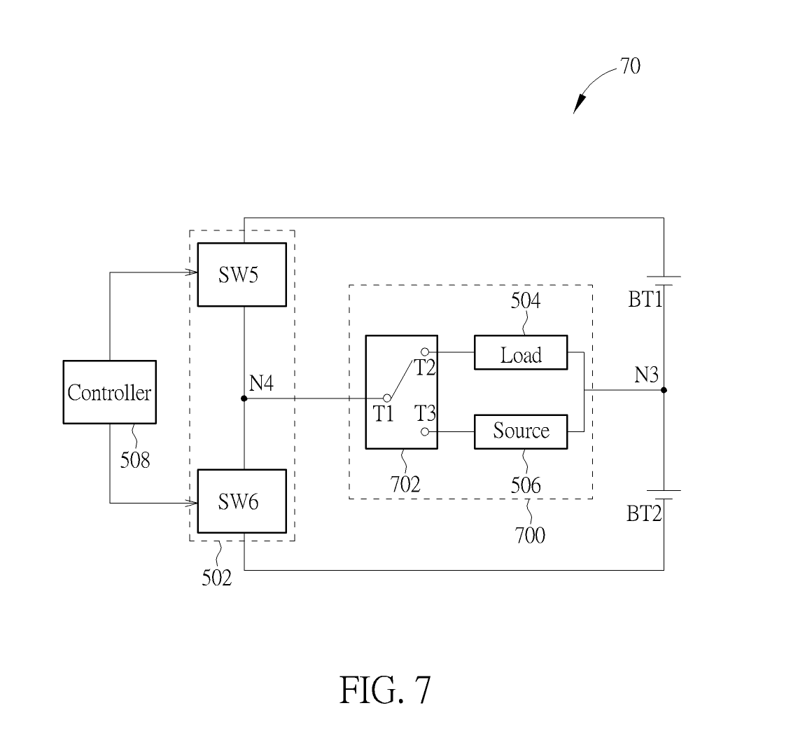

Similarly, a switching unit may also be added into the half bridge multi-function apparatus 50. Please refer to FIG. 7, which is a schematic diagram of a multi-function apparatus 70 according to an embodiment of the present invention. The multi-function apparatus 70 is similar to the multi-function apparatus 50, and thus, the same units are denoted by the same symbols. Different from the multi-function apparatus 50, a center segment 700 of the multi-function apparatus 70 further comprises a switching unit 702. The structure and the operational principles of the switching unit 702 are similar to those of the switching unit 602, which is not narrated herein for brevity. Notably, in FIG. 7, the switching unit 702 is connected to the node N4, and the load unit 304 and the source unit 306 are connected to the node N3, which is not limited herein. In another embodiment, the switching unit 702 may be connected to the node N3, and the load unit 304 and the source unit 306 are connected to the node N4.

Furthermore, in the embodiments described above, the load unit 304 is a speaker load and the source unit 306 is connected to an AC power source or a secondary of a power transformer, which is not limited herein. In another embodiment, the load unit 304 may be a motor and the source unit 306 may be connected to an electric generator. In such a situation, the full bridge circuit HB and the half bridge circuit 502 in the multi-function apparatuses 30 and 50 function as a generator rectifier and a motor drive alternatively, depending on whether or not the source unit 306 is connected to the electric generator. Similarly, the full bridge circuit and the half bridge circuit in the multi-function apparatuses 60 and 70 function as a generator rectifier and a motor drive alternatively, depending on which terminal of the switching unit 702 is connected to the terminal T1 of the switching unit 702.

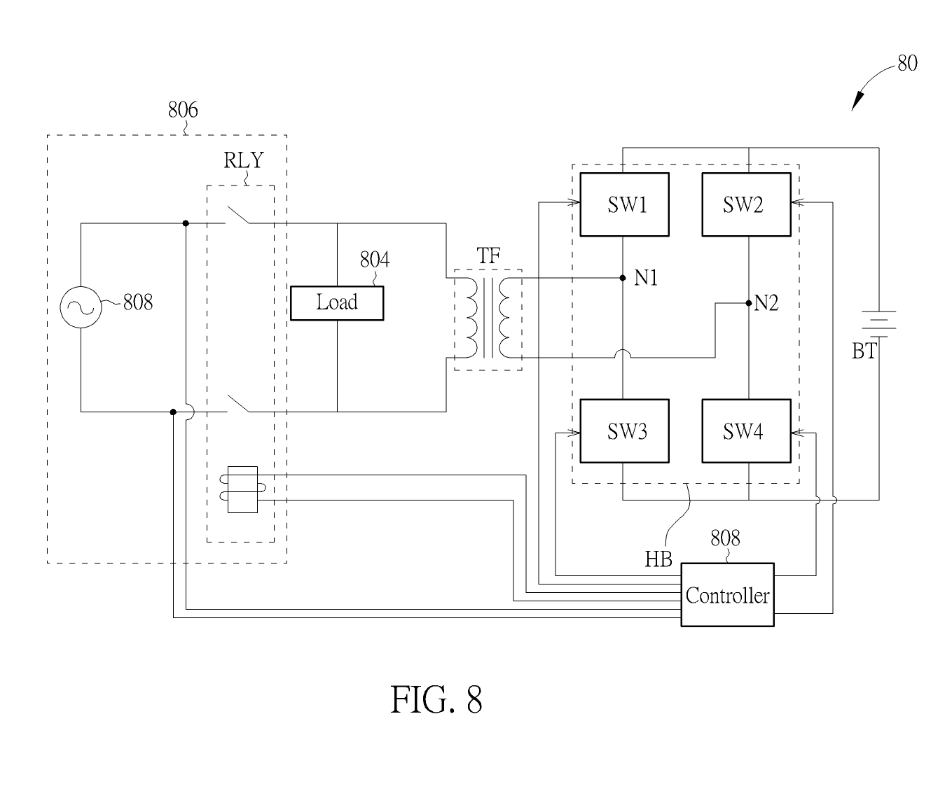

In practice, the multi-function apparatus may be applied to an uninterrupted power supply (UPS) system. Please refer to FIG. 8, which is a schematic diagram of a multi-function apparatus 80 applying to an UPS system according to an embodiment of the present invention. The multi-function apparatus 80 is similar to the multi-function apparatus 30, and thus, the same units are denoted by the same symbols. Different from the multi-function apparatus 30, a transformer TF is connected between the node N1 and the node N2. In addition, a source unit 806 further comprises a relay unit RLY. When an AC power source 808 is active, the relay unit RLY is on. The transformer transforms a voltage of the AC power source 808 into a battery voltage suitable for the energy storage element BT, and charges the energy storage element BT. Hence, the full bridge circuit HB functions as a rectifier to regulate the charging current. On the other hand, if the AC power source 808 fails, the relay RLY is off. The battery voltage is transformed into the power source voltage (e.g., 110 V) through the transformer TF, and electric power is fed to a load 804 through an AC outlet (not illustrated). In this case, the full bridge circuit HB functions as an output driver.

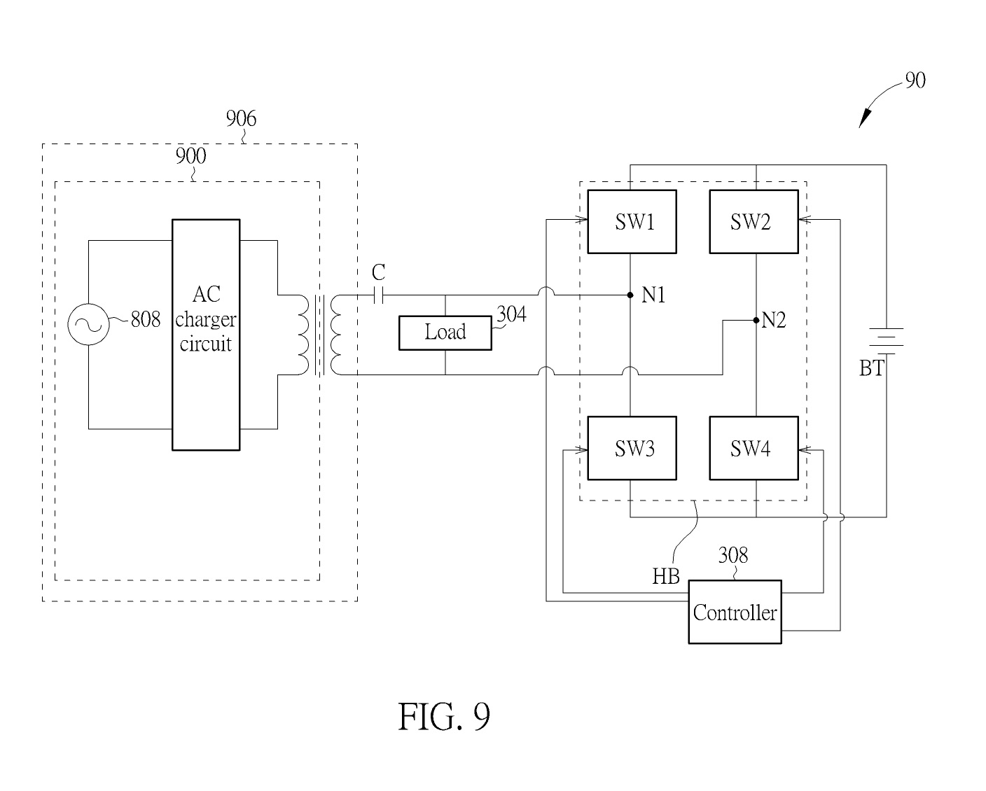

In addition, the source unit may be inductively coupled to an external energy source. For example, please refer to FIG. 9, which is a schematic diagram of a multi-function apparatus 90 according to an embodiment of the present invention. The multi-function apparatus 90 is similar to the multi-function apparatus 30, and thus, the same units are denoted by the same symbols. Different from the multi-function apparatus 30, a source unit 906 in the multi-function apparatus 90 may comprise a contactless charging device 900, depending on whether the contactless charging device 900 is hooked up. The contactless charging device 900 comprises an external AC power source bringing an AC voltage with an AC frequency. In addition, a capacitor C is connected between the load unit 304 and the source unit 906. The load unit 304 herein is a device with a high inductance at the AC frequency, such as a speaker or a motor driving a mechanical load such as a tooth brush, a shaver, etc. When the source unit 906 is inductively coupled to the contactless charging device 900, since the inductance of the load 304 is high, a current flowing through the load 304 is rare and the load 304 does not function. Through a transformer in the source unit 906, the AC voltage provided by the contactless charging device 900 is regulated by the full bridge circuit HB to charge the energy storage element BT, and the full bridge circuit HB acts as a rectifier. On the other hand, when the contactless charging device 900 is removed, the load 304 is driven by a low frequency signal, which is blocked by the capacitor C and causes no effect on the source unit. Thus, the full bridge circuit HB acts as an output driver.

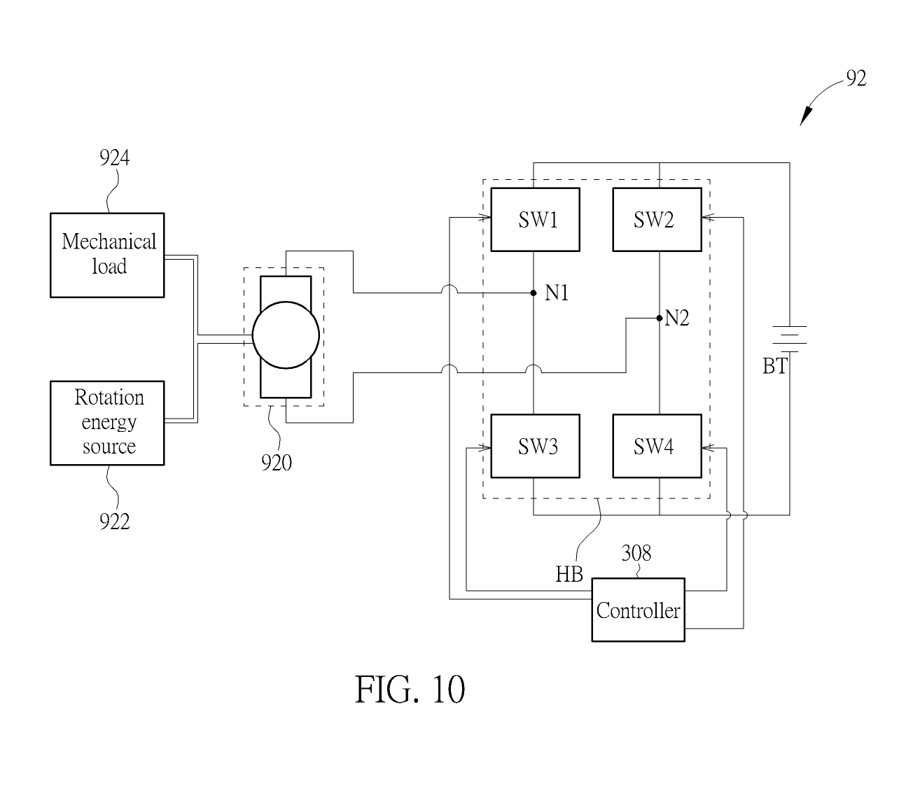

Furthermore, since there are certain devices which are capable of both providing charging currents to the energy storage element and loading discharging current from the energy storage element, e.g., some motors which are able to work as electrical generators, the source unit and the load unit in FIG. 3 may be combined into one device. Please refer to FIG. 10, which is a schematic diagram of a multi-function apparatus 92 according to an embodiment of the present invention. The multi-function apparatus 92 is similar to the multi-function apparatus 30, and thus, the same units are denoted by the same symbols. Different from the multi-function apparatus 30, the multi-function apparatus 92 comprises a combined segment 920 connecting between the node N1 and the node N2. The combined segment 920 may comprise a coil and rotors (not illustrated), capable of working as a motor or an electrical generator alternatively. When a rotation energy source 922 drives the rotors of the combined segment 920, the combined segment 920 acts as an electrical generator and the full bridge circuit HB acts as a rectifier. Otherwise, when there is no external rotation energy, the combined segment 920 acts as a motor driving an external mechanical load 924, and the full bridge circuit HB acts as a motor driver.

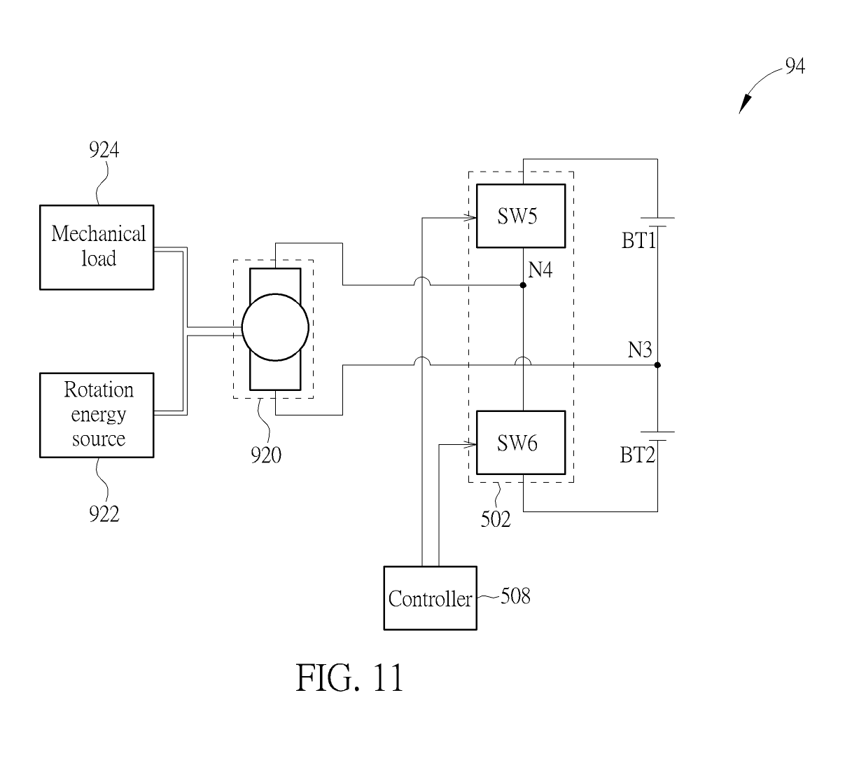

Similarly, the combined segment 920 may be applied to a multi-function apparatus with half bridge circuit. Please refer to FIG. 11, which is a schematic diagram of a multi-function apparatus 94 according to an embodiment of the present invention. The multi-function apparatus 94 is similar to the multi-function apparatus 50 and the multi-function apparatus 92, and thus, the same units are denoted by the same symbols. The multi-function apparatus 94 comprises the combined segment 920 and the half bridge circuit 502. Operation principles of the multi-function apparatus 92 are similar to the multi-function apparatus 50 and the multi-function apparatus 92, which are not narrated herein for brevity.

In summary, since different functional modules may have parts of circuits which are in common, in the present invention, the multi-function apparatuses utilize the bi-directional switches and the center segment comprising different functional units, such that the functional units share the common part of circuits. In such a situation, the common part of circuits within the multi-function apparatuses of the present invention plays different roles alternatively. Thus, the usage of layout area and pins for implementing the multi-function apparatuses are further reduced.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A multi-function apparatus, comprising:
an energy storage element, comprising a positive electrode and a negative electrode;
a full bridge circuit, connected to the energy storage element in parallel, comprising:
a first node;
a second node;
a first switch, electrically connected between the positive electrode of the energy storage element and the first node;
a second switch, electrically connected between the positive electrode of the energy storage element and the second node;
a third switch, electrically connected between the first node and the negative electrode of the energy storage element; and
a fourth switch, electrically connected between the second node and the negative electrode of the energy storage element; and
a center segment, electrically connected between the first node and the second node, comprising:
a source unit, electrically connected between the first node and the second node, configured to provide a charging current to the energy storage element when the source unit is coupled to an external energy source; and
a load unit, electrically connected between the first node and the second node, configured to load a discharging current provided from the energy storage element when the source unit is not coupled to the external energy source.

2. The multi-function apparatus of claim 1, wherein the first switch and the fourth switch are controlled to be on for conducting the charging current to the energy storage element from the source unit or conducting the discharging current to the load unit from the energy storage element, the second switch and the third switch are controlled to be on for conducting the charging current to the energy storage element from the source unit or conducting the discharging current to the load unit from the energy storage element.

3. The multi-function apparatus of claim 1, wherein the first switch, the second switch, the third switch and the fourth switch are bi-directional switches, capable of conducting electric currents from the first terminal to the second terminal of each switch as well as from the second terminal to the first terminal.

4. The multi-function apparatus of claim 3, wherein the bi-directional switches are metal oxide semiconductor (MOS) transistors.

5. The multi-function apparatus of claim 1, wherein when the source unit is coupled to the external energy source, the full bridge circuit functions as a charging rectifier.

6. The multi-function apparatus of claim 5, wherein when the external energy source is an AC power source, the full bridge circuit functions as a power source rectifier.

7. The multi-function apparatus of claim 5, wherein when the external energy source is a secondary of a power transformer, and the full bridge circuit functions as a power source rectifier.

8. The multi-function apparatus of claim 5, wherein when the external energy source is a generator, the full bridge circuit functions as a generator rectifier.

9. The multi-function apparatus of claim 1, wherein when the source unit is not coupled to the external energy source, the full bridge circuit functions as a load driver.

10. The multi-function apparatus of claim 9, wherein when the load unit is an audio speaker, the full bridge circuit functions as an audio speaker driver.

11. The multi-function apparatus of claim 9, wherein when the load unit is a motor, the full bridge circuit functions as a motor driver.

12. The multi-function apparatus of claim 1, wherein the center segment further comprises a switching unit, comprising a first terminal electrically connected to the first node, a second terminal electrically connected to the source unit, and a third terminal electrically connected to the load unit, configured to conduct either a connection between the first terminal and the second terminal of the switching unit or a connection between the first terminal and the third terminal of the switching unit.

13. A multi-function apparatus, comprising:
a first node;
a first energy storage element, comprising a positive electrode and a negative electrode connected to the first node;
a second energy storage element, comprising a positive electrode connected to the first node and a negative electrode;
a half bridge circuit, having a terminal connected to the positive electrode of the first energy storage element and another terminal connected to the negative electrode of the second energy storage element, comprising:
a second node;
a first switch, electrically connected between the positive electrode of the first energy storage element and the second node;
a second switch, electrically connected between the second node and the negative electrode of the second energy storage element; and
a center segment, electrically connected between the first node and the second node, comprising:
a source unit, electrically connected between the first node and the second node, for providing a charging current to the energy storage element when the source unit is coupled to an external energy source; and
a load unit, electrically connected between the first node and the second node, for loading a discharging current provided from the energy storage element when the source unit is not coupled to the external energy source.

14. The multi-function apparatus of claim 13, wherein the first switch is controlled to be on for conducting the charging current to the first energy storage element from the source unit or conducting the discharging current to the load unit from the first energy storage element, the second switch is controlled to be on for conducting the charging current to the second energy storage element from the source unit or conducting the discharging current to the load unit from the second energy storage element.

15. The multi-function apparatus of claim 13, wherein the first switch and the second switch are bi-directional switches, capable of conducting electric currents from the first terminal to the second terminal of each switch as well as from the second terminal to the first terminal.

16. The multi-function apparatus of claim 15, wherein the bi-directional switches are metal oxide semiconductor (MOS) transistors.

17. The multi-function apparatus of claim 15, wherein when the source unit is coupled to the external energy source, the full bridge circuit functions as a charging rectifier.

18. The multi-function apparatus of claim 17, wherein when the external energy source is an AC power source, the full bridge circuit functions as a power source rectifier.

19. The multi-function apparatus of claim 17, wherein when the external energy source is a secondary of a power transformer, and the full bridge circuit functions as a power source rectifier.

20. The multi-function apparatus of claim 17, wherein when the external energy source is a generator, the full bridge circuit functions as a generator rectifier.

21. The multi-function apparatus of claim 13, wherein when the source unit is not coupled to the external energy source, the full bridge circuit functions as a load driver.

22. The multi-function apparatus of claim 21, wherein when the load unit is an audio speaker, the full bridge circuit functions as an audio speaker driver.

23. The multi-function apparatus of claim 21, wherein when the load unit is a motor, the full bridge circuit functions as a motor driver.

24. The multi-function apparatus of claim 13, wherein further comprises a switching unit, comprising a first terminal electrically connected to the first node, a second terminal electrically connected to the source unit, and a third terminal electrically connected to the load unit, configured to conduct either a connection between the first terminal and the second terminal of the switching unit or a connection between the first terminal and the third terminal of the switching unit.

25. A multi-function apparatus, comprising:
an energy storage element, comprising a positive electrode and a negative electrode;
a full bridge circuit, connected to the energy storage element in parallel, comprising:
a first node;
a second node;
a first switch, electrically connected between the positive electrode of the energy storage element and the first node;
a second switch, electrically connected between the positive electrode of the energy storage element and the second node;
a third switch, electrically connected between the first node and the negative electrode of the energy storage element; and
a fourth switch, electrically connected between the second node and the negative electrode of the energy storage element; and
a combined segment, electrically connected between the first node and the second node, configured to provide a charging current to the energy storage element or load a discharging current provided from the energy storage element.

26. The multi-function apparatus of claim 25, wherein the first switch and the fourth switch are controlled to be on for conducting the charging current to the energy storage element from the combined segment or conducting the discharging current to the combined segment from the energy storage element, the second switch and the third switch are controlled to be on for conducting the charging current to the energy storage element from the combined segment or conducting the discharging current to the combined segment from the energy storage element.

27. The multi-function apparatus of claim 25, wherein the first switch, the second switch, the third switch and the fourth switch are bi-directional switches, capable of conducting electric currents from the first terminal to the second terminal of each switch as well as from the second terminal to the first terminal.

28. The multi-function apparatus of claim 27, wherein the bi-directional switches are metal oxide semiconductor (MOS) transistors.

29. The multi-function apparatus of claim 25, wherein when the combined segment provides the charging current to the energy storage element, the full bridge circuit functions as a charging rectifier.

30. The multi-function apparatus of claim 25, wherein when the combined segment loads the discharging current provided from the energy storage element, the full bridge circuit functions as a load driver.

31. The multi-function apparatus of claim 25, wherein the combined segment comprises a rotor.

32. The multi-function apparatus of claim 31, wherein the combined segment provides the charging current to the energy storage element when an external energy drives the rotor, and the combined segment loads a discharging current provided from the energy storage element when no external energy drives the rotor.

33. A multi-function apparatus, comprising:
a first node;
a first energy storage element, comprising a positive electrode and a negative electrode connected to the first node;
a second energy storage element, comprising a positive electrode connected to the first node and a negative electrode;
a half bridge circuit, having a terminal connected to the positive electrode of the first energy storage element and another terminal connected to the negative electrode of the second energy storage element, comprising:
a second node;
a first switch, electrically connected between the positive electrode of the first energy storage element and the second node;
a second switch, electrically connected between the second node and the negative electrode of the second energy storage element; and
a combined segment, electrically connected between the first node and the second node, configured to provide a charging current to the energy storage element or load a discharging current provided from the energy storage element.

34. The multi-function apparatus of claim 33, wherein the first switch are controlled to be on for conducting the charging current to the first energy storage element from the combined segment or conducting the discharging current to the combined segment from the first energy storage element, the second switch is controlled to be on for conducting the charging current to the second energy storage element from the combined segment or conducting the discharging current to the combined segment from the second energy storage element.

35. The multi-function apparatus of claim 31, wherein the first switch and the second switch are bi-directional switches, capable of conducting electric currents from the first terminal to the second terminal of each switch as well as from the second terminal to the first terminal.

36. The multi-function apparatus of claim 35, wherein the bi-directional switches are metal oxide semiconductor (MOS) transistors.

37. The multi-function apparatus of claim 33, wherein when the combined segment provides the charging current to the energy storage element, the full bridge circuit functions as a charging rectifier.

38. The multi-function apparatus of claim 33, wherein when the combined segment loads the discharging current provided from the energy storage element, the full bridge circuit functions as a load driver.

39. The multi-function apparatus of claim 33, wherein the combined segment comprises a rotor.

40. The multi-function apparatus of claim 39, wherein the combined segment provides the charging current to the energy storage element when an external energy drives the rotor, and the combined segment loads a discharging current provided from the energy storage element when no external energy drives the rotor.
